(19) United States
(12) Patent Application Publication
(10) Pub. No.: US 2016/0200604 A1
(43) Pub. Date: Jul. 14, 2016

(54) METHOD OF ADVANCED REMOVAL OF PERSISTENT ORGANIC POLLUTANTS AND HEAVY METALS IN WATER BODY

(71) Applicant: Fengchun Xie, Guangzhou (CN)

(72) Inventor: Fengchun Xie, Guangzhou (CN)

(21) Appl. No.: 15/075,154

(22) Filed: Mar. 20, 2016

Related U.S. Application Data
(63) Continuation of application No. PCT/CN2013/085096, filed on Oct. 12, 2013.

(30) Foreign Application Priority Data
Sep. 30, 2013 (CN) 201310458002.0

(51) Int. Cl. C02F 1/72; C02F 1/28

(52) U.S. Cl. CPC C02F 1/722; C02F 1/281; C02F 1/72; C02F 2101/20

(57) ABSTRACT

The present invention provides a method of advanced removal of heavy metals in a water body, can be used for the advanced removal of heavy metals in the water body and belongs to the technical field of environmental protection. In the present method, the heavy metals are captured in the water body by a capturing agent firstly and are made into solid-phase surfaces; an oxidizing agent is then used to oxidize the captured heavy metals such that the heavy metals are converted, due to the oxidization of a complexing agent, from being in complexes to being free and then precipitate into solids, or the heavy metals are converted to having high valences and then precipitate into solids; at the same time the capturing agent is restored. The advanced removal of heavy metals from the water body is thereby achieved. And the capturing agent can be recycled. The method of the present invention is of high efficiency, low cost and simple treatment process, which can achieve the advanced removal of heavy metals in the water body.

### CROSS-REFERENCE TO RELATED APPLICATIONS

This application is a continuation of International Patent Application No. PCT/CN2013/085096 with an international filing date of Oct. 12, 2013, designating the United States, now pending, and further claims priority benefits to Chinese Patent Application No. 201310458002.0 , filed Sep. 30, 2013. The contents of all of the aforementioned applications, including any intervening amendments thereto, are incorporated herein by reference.

### TECHNICAL FIELD

The present invention relates to a method of advanced removal of heavy metals in a water body and belongs to the technical field of environmental protection.

### BACKGROUND OF THE PRESENT INVENTION

Heavy metals are harmful to the environment and human health because of the characteristics of persistence, bioaccumulation, migration and high toxicity. In modern times, with the development of industry, the heavy metals will be produced more and more, which raises a great challenge to the environmental protection. The advanced removal of heavy metals from the water body must be achieved to protect the water environment. And there exists multiple methods of advanced removal of heavy metals from the water body, such as biological treatment, adsorption, precipitation, and advanced oxidation process, however, these methods have some limitations in different degrees, such as low treatment efficiency, high cost and difficult process. Therefore, it is necessary to provide a method of advanced removal of heavy metals in the water body with high efficiency, low cost and simple treatment process.

### SUMMARY OF THE PRESENT INVENTION

The present invention aims to provide a method of advanced removal of heavy metals in the water body with high efficiency, low cost and simple treatment process. In the present method, the heavy metals are captured in the water body by the capturing agent firstly, are made into solid-phase surfaces, and are made to change the electron cloud distribution, such that the oxidization trend is increased, and the activation energy of oxidization reaction is decreased; an oxidizing agent is then used to oxidize the captured heavy metals such that the heavy metals are converted, due to the oxidization of a complexing agent, from being in complexes to being free and then precipitate into solids, or the heavy metals are converted to having high valences and then precipitate into solids; at the same time the capturing agent is restored. The advanced removal of heavy metals from the water body is thereby achieved. And the capturing agent can be recycled.

The method of the present invention comprise following steps of:

1. adding the capturing agent in the water body to be processed;

2. adding oxidizing agent and mixing completely for oxidization reaction of the captured heavy metals by the capturing agent, and the capturing agent is restored, capturing the heavy metals in the water body again, and the heavy metals are oxidized again, repeating above steps until the heavy metals from the water body are completely oxidized;

3. carrying out solid-liquid separation such that the water body is separated with the capturing agent and precipitated heavy metals. The capturing agent can be recycled, and the advanced removal of heavy metals from the water body is achieved.

The method of the present invention can achieve the advanced removal of heavy metals in the water body with high efficiency, low cost and simple treatment process.

### DETAILED DESCRIPTION OF PREFERRED EMBODIMENTS

The detailed description and effect of the present invention are further explained by following non-defining embodiments.

### Embodiment 1

The exhausted content of wastewater lead of some chemical plant is 10 mg/L, and the content of EDTA is 50 mg/L. The removal method according to the present invention is taken as follows.

1. adjusting the pH value of wastewater to 9-10;

2. adding the capturing agent composed of one or more combination of macromolecule capturing agent, ferric oxide, aluminium oxide or manganese dioxide;

3. adding hydrogen peroxide solution, mixing completely and reacting for 5 minutes;

4. carrying out solid-liquid separation, the obtained solid phase capturing agent can be recycled, and the liquid phase capturing agent is aqueous phase, of which the lead is advanced removed.

The content of processed wastewater lead and EDTA is below 0.01 mg/L according to above method.

### Embodiment 2

The exhausted content of wastewater thallium of some melting plant is 200 μg/L. The removal method according to the present invention is taken as follows.

1. adjusting the pH value of wastewater to 9-10;

2. adding the capturing agent composed of one or more combination of macromolecule capturing agent, ferric oxide aluminium oxide or manganese dioxide;

3. adding potassium permanganate solution, mixing completely and reacting for 5 minutes;

4. carrying out solid-liquid separation, the obtained solid phase capturing agent can be recycled, and the liquid phase capturing agent is aqueous phase, of which the thallium is advanced removed.

The content of processed wastewater thallium is below 0.01 μg/L according to above method.

Above disclosure merely shows several preferred embodiments of the present invention, not the limitation about the scope of the invention, and the present invention is not limited thereto; Any variations and improvements based on the technical proposal of the invention that may come into the mind of those skilled in the art shall fall into the protection scope of the present invention. So other embodiments obtained by the scope of claims shall belong to the protection scope of the present invention.

I claim:

1. A method of advanced removal of heavy metals in a water body, characterized by adding capturing agent and oxidizing agent, mixing completely for oxidization reaction of the captured heavy metals by capturing agent, and the capturing agent is restored, capturing the heavy metals in the water body again, and the heavy metals are oxidized again, repeating above steps until the heavy metals from the water body are completely oxidized, such that the heavy metals are converted, due to the oxidization of a complexing agent, from being in complexes to being free and then precipitate into solids, or the heavy metals are converted to having high valences and then precipitate into solids; at the same time the capturing agent is restored.

2. The method according to claim 1, characterized in that the capturing agent is composed of one or more combination of macromolecule capturing agent, ferric oxide, aluminium oxide or manganese dioxide.

3. The method according to claim 1, characterized in that the oxidizing agent is composed of one or more combination of potassium ferrate, potassium perchlorate, potassium permanganate, hydrogen peroxide, sodium persulfate and sodium hypochlorite.
